(19) United States
(12) Patent Application Publication
(10) Pub. No.: US 2024/0028234 A1
(43) Pub. Date: Jan. 25, 2024

(54) MULTI-FINGERPRINT DEDUPLICATION PROCESSING

(71) Applicant: Dell Products L.P., Round Rock, TX (US)

(72) Inventor: Philippe Armangau, Kalispell, MT (US)

(21) Appl. No.: 17/869,127

(22) Filed: Jul. 20, 2022

(51) Int. Cl. G06F 3/06

(52) U.S. Cl. CPC G06F 3/0641; G06F 3/0608; G06F 3/0689

(57) ABSTRACT

A technique for performing deduplication calculates a first fingerprint of a candidate block using a first function and a second fingerprint of the candidate block using a second function. The technique uses the first fingerprint to identify a target block, which is a potential match to the candidate block in the storage system. The technique then attempts to verify the potential match by accessing a fingerprint of the target block, which was previously calculated using the second function. The technique compares the fingerprint of the target block to the second fingerprint of the candidate block. A match between the two fingerprints confirms that the data of the candidate block matches the data of the target block. Storage of the candidate block can then be effectuated by reference to the target block.

### BACKGROUND

Data storage systems are arrangements of hardware and software in which storage processors are coupled to arrays of non-volatile storage devices, such as magnetic disk drives, electronic flash drives, and/or optical drives. The storage processors, also referred to herein as “nodes,” service storage requests arriving from host machines (“hosts”), which specify blocks, files, and/or other data elements to be written, read, created, deleted, and so forth. Software running on the nodes manages incoming storage requests and performs various data processing tasks to organize and secure the data elements on the non-volatile storage devices.

Many storage systems promote data reduction using deduplication. Deduplication is a technology that reduces the number of duplicate copies of data. A common deduplication scheme includes a digest database that associates hash values of data blocks with locations where those data blocks can be found. The hash values have sufficient uniqueness that a match between hash values computed from two blocks indicates a match between the two blocks themselves. When a storage system receives a new block for storage, the storage system may compute a hash value of the new block and perform a lookup for that hash value in the digest database. If a match is found, the storage system may conclude that the new block is already present. The storage system can then effectuate storage of the new block merely by setting a pointer from a logical address of the new block to a target block pointed to by the matching entry in the database. Storage of a duplicate copy of the data of the new block is therefore avoided.

### SUMMARY

Some storage systems use fully cryptographic hash functions for deduplication. Such hash functions produce hash values with very high entropy, such that false matches between data blocks based on hash-value comparisons become a statistical impossibility. Such fully cryptographic hash functions are computationally intensive to execute, however. They also produce large hash values as results, such as values having sizes greater than 128 bits. Storing such large hash values on a per-block basis can consume considerable storage space.

To address these deficiencies, some storage systems use weaker hash functions that are easier to compute than fully cryptographic hash functions and produce smaller hash values (e.g., 64 bits or less). As it is not impossible for false-positives to occur with smaller hash values, a storage system may perform an additional step of verifying hash-based matches by comparing the data of blocks directly. For example, if a deduplication attempt on a candidate block produces a hash-based match to a target block, the storage system may confirm the match by performing a bit comparison between the candidate block and the target block. Unfortunately, bit comparisons require access to both the candidate block and the target block, however, and it is not always efficient or convenient to provide access to both. What is needed, therefore, is a deduplication solution that allows weaker hash functions to be used without requiring access to the data of blocks for bit comparisons.

To address the above need at least in part, an improved technique for performing deduplication uses at least two fingerprints instead of one. To perform deduplication on a candidate block, the improved technique calculates a first fingerprint of the candidate block using a first function and a second fingerprint of the candidate block using a second function. The technique uses the first fingerprint to identify a target block, which is a potential match to the candidate block in the storage system. The technique then attempts to verify the potential match by accessing a fingerprint of the target block, which was previously calculated using the second function. The technique compares the fingerprint of the target block to the second fingerprint of the candidate block. A match between the two fingerprints confirms that the data of the candidate block matches the data of the target block. Storage of the candidate block can then be effectuated by reference to the target block.

Advantageously, a match between the candidate block and the target block can be confirmed without having to access both blocks at the same time. Rather, matches can be confirmed based on fingerprints only. Also, use of the first fingerprint for identifying the potential target block enables the storage system to operate more efficiently than would be possible if larger fingerprints were used.

The improved technique is especially attractive when performing deduplication-enabled replication. In such arrangements, a source storage system identifies blocks to be replicated and sends fingerprints of those blocks to a destination storage system, which attempts to match the fingerprints with those of target blocks already stored at the destination. Providing both first and second fingerprints of blocks to be replicated enables the destination to find matches without requiring access to the blocks at the source. Replication can therefore proceed without the need to transmit blocks that are already present at the destination, increasing speed and reducing network traffic and congestion.

In some examples, a storage system uses the first fingerprint of a block (or a portion of the first fingerprint) as a checksum for that block, i.e., as a value for validating the data of the block. As checksums are useful regardless of deduplication, storing the first fingerprint or a portion thereof in a checksum means that less space is needed for storing fingerprints. Thus, the size of the checksum effectively subtracts from the space required for storing the first and second fingerprints. Also, calculating a checksum is a common task in a storage system. Basing the checksum on the first fingerprint, which itself is easy to calculate, thus ensures that the checksum is also easy to calculate. The storage advantages gained by basing the checksum on the first fingerprint do not impose a severe computational burden when it comes to calculating the checksum. It is noted that the computational burden would be more severe, however, if the checksum were instead based on a fully cryptographic hash function.

Certain embodiments are directed to a method of performing deduplication in a storage system. The method includes obtaining (i) a first fingerprint calculated from a candidate block using a first function and (ii) a second fingerprint calculated from the candidate block using a second function. The method further includes identifying a target block that the storage system associates with the first fingerprint and confirming that the target block matches the candidate block by (i) reading a fingerprint of the target block previously calculated using the second function and (ii) determining that the fingerprint of the target block matches the second fingerprint, the storage system then effectuating storage of the candidate block by reference to the target block.

Other embodiments are directed to a method of performing deduplication-enabled replication. The method includes calculating, by a source storage system (i) a first fingerprint of a candidate block using a first function and (ii) a second fingerprint of the candidate block using a second function. The method further includes sending, by the source storage system, the first fingerprint and the second fingerprint to a destination storage system, identifying, by the destination storage system, a target block that the destination storage system associates with the first fingerprint, and confirming, by the destination storage system, that the target block matches the candidate block by (i) reading a fingerprint of the target block previously calculated using the second function and (ii) determining that the fingerprint of the target block matches the second fingerprint, the destination storage system then effectuating storage of the candidate block by reference to the target block.

Other embodiments are directed to a computerized apparatus constructed and arranged to perform any of the methods described above. Still other embodiments are directed to a computer program product. The computer program product stores instructions which, when executed on control circuitry of a computerized apparatus, cause the computerized apparatus to perform any of the methods described above.

The foregoing summary is presented for illustrative purposes to assist the reader in readily grasping example features presented herein; however, this summary is not intended to set forth required elements or to limit embodiments hereof in any way. One should appreciate that the above-described features can be combined in any manner that makes technological sense, and that all such combinations are intended to be disclosed herein, regardless of whether such combinations are identified explicitly or not.

### BRIEF DESCRIPTION OF THE SEVERAL VIEWS OF THE DRAWINGS

The foregoing and other features and advantages will be apparent from the following description of particular embodiments, as illustrated in the accompanying drawings, in which like reference characters refer to the same or similar parts throughout the different views.

FIG. 1 is a block diagram of an example environment in which embodiments of the improved technique can be practiced.

FIG. 2 is a block diagram of an example data path as shown in FIG. 1.

FIG. 3 is a block diagram of an example arrangement for generating fingerprints in accordance with certain embodiments.

FIG. 4 is a flowchart showing an example method of performing deduplication in the environment of FIG. 1.

FIG. 5 is a block diagram showing an example arrangement for performing replication.

FIG. 6 is a flowchart showing an example method for performing deduplication.

### DETAILED DESCRIPTION

Embodiments of the improved technique will now be described. One should appreciate that such embodiments are provided by way of example to illustrate certain features and principles but are not intended to be limiting.

An improved technique for performing deduplication calculates a first fingerprint of a candidate block using a first function and a second fingerprint of the candidate block using a second function. The technique uses the first fingerprint to identify a target block, which is a potential match to the candidate block in the storage system. The technique then attempts to verify the potential match by accessing a fingerprint of the target block, which was previously calculated using the second function. The technique compares the fingerprint of the target block to the second fingerprint of the candidate block. A match between the two fingerprints confirms that the data of the candidate block matches the data of the target block. Storage of the candidate block can then be effectuated by reference to the target block.

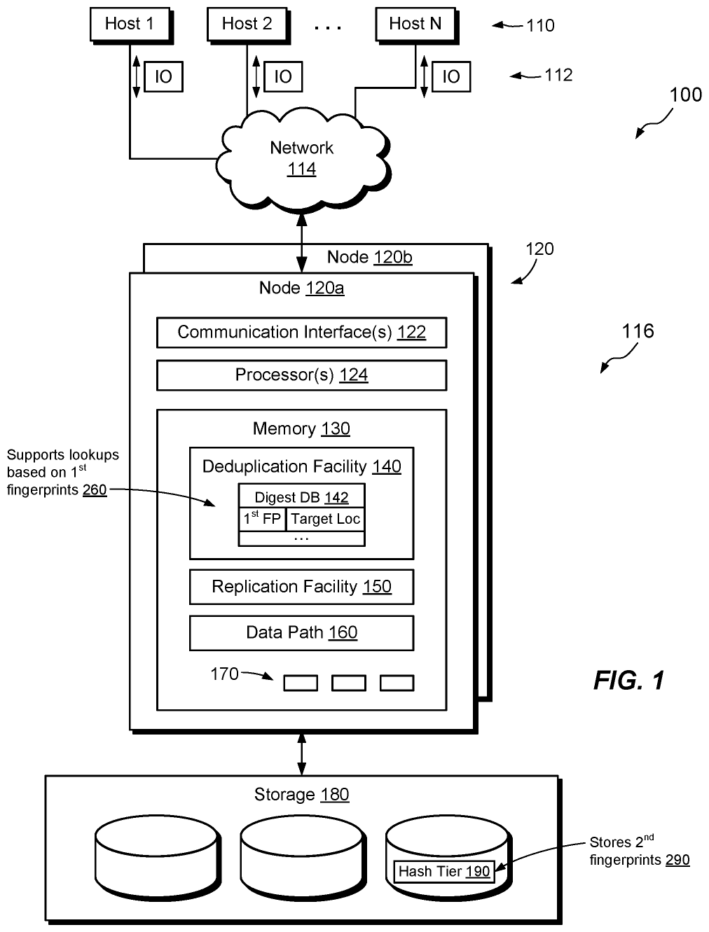

FIG. 1 shows an example environment 100 in which embodiments of the improved technique can be practiced. Here, multiple hosts 110 are configured to access a data storage system 116 over a network 114. The data storage system 116 includes one or more nodes 120 (e.g., node 120a and node 120b), and storage 180, such as magnetic disk drives, electronic flash drives, and/or the like. Nodes 120 may be provided as circuit board assemblies or blades, which plug into a chassis (not shown) that encloses and cools the nodes. The chassis has a backplane or midplane for interconnecting the nodes 120, and additional connections may be made among nodes 120 using cables. In some examples, the nodes 120 are part of a storage cluster, such as one which contains any number of storage appliances, where each appliance includes a pair of nodes 120 connected to shared storage. In some arrangements, a host application runs directly on the nodes 120, such that separate host machines 110 need not be present. No particular hardware configuration is required, however, as any number of nodes 120 may be provided, including a single node, in any arrangement, and the node or nodes 120 can be any type or types of computing device capable of running software and processing host 110's.

The network 114 may be any type of network or combination of networks, such as a storage area network (SAN), a local area network (LAN), a wide area network (WAN), the Internet, and/or some other type of network or combination of networks, for example. In cases where hosts 110 are provided, such hosts 110 may connect to the node 120 using various technologies, such as Fibre Channel, iSCSI (Internet small computer system interface), NVMeOF (Nonvolatile Memory Express (NVMe) over Fabrics), NFS (network file system), and CIFS (common Internet file system), for example. As is known, Fibre Channel, iSCSI, and NVMeOF are block-based protocols, whereas NFS and CIFS are file-based protocols. The node 120 is configured to receive I/O requests 112 according to block-based and/or file-based protocols and to respond to such I/O requests 112 by reading or writing the storage 180.

The depiction of node 120a is intended to be representative of all nodes 120. As shown, node 120a includes one or more communication interfaces 122, a set of processors 124, and memory 130. The communication interfaces 122 include, for example, SCSI target adapters and/or network interface adapters for converting electronic and/or optical signals received over the network 114 to electronic form for use by the node 120a. The set of processors 124 includes one or more processing chips and/or assemblies, such as numerous multi-core CPUs (central processing units). The memory 130 includes both volatile memory, e.g., RAM (Random Access Memory), and non-volatile memory, such as one or more ROMs (Read-Only Memories), disk drives, solid state drives, and the like. The set of processors 124 and the memory 130 together form control circuitry, which is constructed and arranged to carry out various methods and functions as described herein. Also, the memory 130 includes a variety of software constructs realized in the form of executable instructions. When the executable instructions are run by the set of processors 124, the set of processors 124 is made to carry out the operations of the software constructs. Although certain software constructs are specifically shown and described, it is understood that the memory 130 typically includes many other software components, which are not shown, such as an operating system, various applications, processes, and daemons.

As further shown in FIG. 1, the memory 130 “includes,” i.e., realizes by execution of software instructions, a deduplication facility 140, a replication facility 150, a data path 160, and any number of data objects 170. The data objects 170 may be any type or types of objects, such as LUNs (Logical UNits), file systems, virtual machine disks, and/or the like. The data objects 170 may be composed of blocks, where a “block” is a unit of allocatable storage space. Blocks are typically uniform in size, with typical block sizes being 4 kB (kilo Bytes), 8 kB, or 16 kB, for example. No particular block size is required, however, and embodiments may support non-uniform block sizes. The data storage system 116 is configured to access the data objects 170 by specifying blocks of the data objects to be created, read, updated, or deleted.

Deduplication facility 140 is configured to perform data deduplication based on both first fingerprints and second fingerprints. Deduplication may be performed in an inline or near-inline manner, using fingerprint-based matching in which duplicate copies are avoided prior to being written to persistent data-object structures. In some examples, deduplication may also be performed in the background, i.e., out of band with the initial processing of incoming writes. Deduplication is sometimes abbreviated as “dedupe.” In some examples, the deduplication facility 140 includes or otherwise has access to a digest database 142, which associates first fingerprints 260 of data blocks with respective locations of those data blocks in the storage system 116.

Replication facility 150 is configured to perform replication on data objects 170. Typically, replication is performed between two data storage systems, with one storage system designated as a “source” and the other storage system designated as a “destination.” The source is the data storage system that “hosts” a data object, i.e., makes the data object available to hosts 110 for reading and/or writing, whereas the destination is the data storage system that maintains a “replica” of the data object, i.e., a copy of the data object that is current or nearly current. In an example, replication facility 150 is configured to perform asynchronous replication, also known as “snapshot shipping.” Asynchronous replication works by taking regular snapshots of a data object on a specified schedule, such as once every five minutes, once every hour, or at some other rate, which is typically defined by an administrator. Each time a new snapshot of the data object is taken, the replication facility 150 computes a deltaset, i.e., a set of changes or differences between blocks of the new snapshot and blocks of the immediately previous snapshot. The replication facility 150 then transmits (“ships”) the deltaset to the destination, which applies the deltaset in updating the replica. Once the update is complete, the contents of the replica are identical to those of the data object as of the most recent snapshot taken at the source.

Data path 160 is configured to provide metadata for accessing data objects, such as data objects 170. As described in more detail below, data path 160 may include various logical blocks, mapping pointers, and block virtualization structures, some of which may track various attributes of blocks.

As further shown in FIG. 1, the data storage system 116 may include a persistent storage region, such as a hash tier 190, which is configured to store certain fingerprint data used for deduplication and/or replication. In an example, the hash tier 190 is formed using one or more high-speed, non-volatile storage devices (e.g., flash drives), such that the nodes 120 are able to access fingerprint data from storage 180 at high speed. As described more fully below, the hash tier 190 is configured to store second fingerprints 290 of data blocks, which are available as target blocks for deduplication. In some examples, the hash tier 190 is further configured to store portions of first fingerprints 260 of data blocks, with other portions of first fingerprints 260 stored in checksums associated with the data blocks.

In example operation, hosts 110 issue I/O requests 112 to the data storage system 116. A node 120 receives the I/O requests 112 at the communication interfaces 122 and initiates further processing. Such processing may include performing deduplication and/or replication. Deduplication employs both first fingerprints 260 and second fingerprints 290. For example, both a first fingerprint 260 and a second fingerprint 290 may be calculated from a candidate block received for storage. The first fingerprint 260 is used to match the candidate block to a potential target block, and the second fingerprint 290 is used to confirm that the match based on the first fingerprint 260 is proper.

Replication as described herein may leverage deduplication using both first and second fingerprints. For example, to replicate a data block of a data object 170 from the data storage system 116 acting as a source to another data storage system acting as a destination, the data storage system 116 may send the first and second fingerprints calculated from the data block along with an LBA (logical block address) of the data block in the data object 170. The data block itself is not sent, however. Upon receiving the fingerprints and LBA, the destination may use the first and second fingerprints to perform inline deduplication, attempting to use the fingerprints to identify a matching target block already stored in the destination. If a match is found, the destination may update a replica of the data object to point to the target block at the indicated LBA. If a matching block cannot be found, then the destination may request and obtain the data block from the source.

The data storage system 116 may also act as a replication destination. For example, a node 120 may receive a transmission from another data storage system (a source). The transmission may include first and second fingerprints of a block and an LBA of the block being replicated. The block itself is not included, however. Upon receiving the transmission, the data storage system 116 attempts inline deduplication using the first and second fingerprints. Here, deduplication operates the same way as described above, except that the first and second fingerprints are received rather than calculated. Also, such fingerprints are based on a block that is not necessarily present. If a match to the block is found, the data storage system 116 may update a replica at the specified LBA, again, without ever receiving the block from the source.

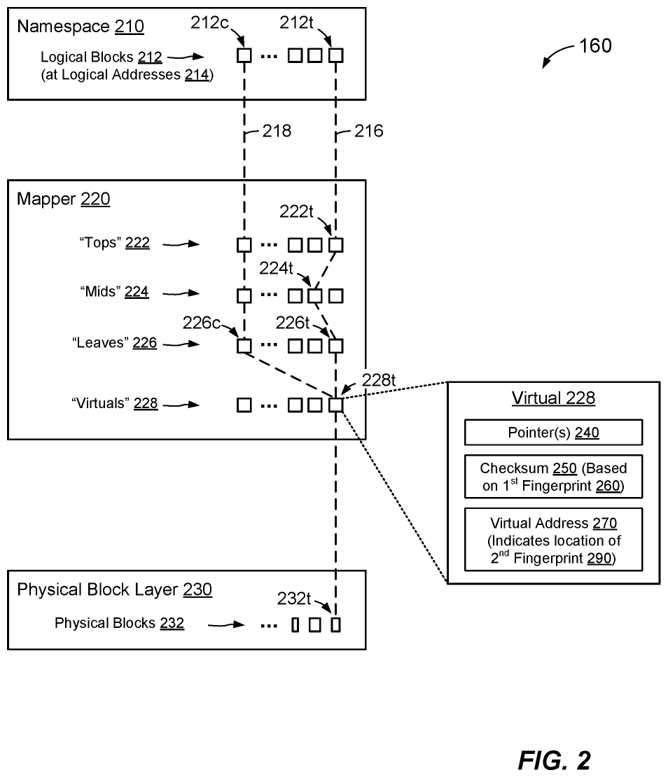

FIG. 2 shows an example of the data path 160 in greater detail. The data path 160 provides an arrangement of metadata in the form of metadata elements, such as pointers, which may be traversed for locating data in the data storage system 116 and for supporting deduplication. As shown, the data path 160 includes a namespace 210, a mapping structure (“mapper”) 220, and a physical block layer 230. The namespace 210 is configured to organize logical data, such as data of LUNs (volumes), file systems, virtual machine disks, snapshots, clones, and/or the like. In an example, the namespace 210 provides a large logical address space and is denominated in logical blocks 212 having associated logical addresses 214.

The mapper 220 is configured to map logical blocks 212 in the namespace 210 to corresponding physical blocks 232 in the physical block layer 230. The physical blocks 232 are normally compressed and may thus have non-uniform size. The mapper 320 may include multiple levels of mapping structures, such as pointers, which are arranged in a tree. The levels include tops 222, mids 224, and leaves 226, which together are capable of mapping large amounts of data. The mapper 220 may also include a layer of virtuals 228, i.e., block virtualization structures for providing indirection between the leaves 226 and physical blocks 232, thus enabling physical blocks 232 to be moved without disturbing leaves 226. Although the tops 222, mids 224, leaves 226, and virtuals 228 depict individual pointer structures, such pointer structures may be grouped together in arrays (not shown), which themselves may be stored in blocks.

In general, logical blocks 212 in the namespace 210 point to respective physical blocks 232 in the physical block layer 230 via mapping structures in the mapper 220. For example, a logical block 212t in the namespace 210 may point, via a path 216, to a particular top 222t, which points to a particular mid 224t, which points to a particular leaf 226t. The leaf 226t points to a particular virtual 228t, which points to a particular physical block 232t. In this manner, the data corresponding to logical block 212t may be found by following the pointers through the mapper to the data 232t.

FIG. 2 further shows an example virtual 228 in greater detail. Here, the virtual 228 is a metadata element that includes a pointer 240 to the data (e.g., to block 232a) as well as a checksum 250 and a virtual address 270. In an example, the checksum 250 is based on a first fingerprint 260 of the data of logical block 212t. For instance, the first fingerprint 260 may be calculated from the block 212t using a first function (e.g., a hash function), and the checksum 250 may be the entirety of the first fingerprint 260 or a portion thereof, e.g., some number of bits of the first fingerprint 260.

The virtual address 270 is an address of the virtual 228, such as an address in a virtual tier (not shown) or some other address associated with the block 212t. The virtual address 270 may be stored explicitly (as a value in the virtual 228), or it may be implied based on a location of the virtual 228, e.g., a location in the virtual tier. In an example, the virtual address 270 directly implies a corresponding location in the hash tier 190 of a second fingerprint 290 calculated from the block 212t. The second fingerprint 290 may be calculated, for example, using a second function (e.g., a different hash function). In an example, the location of the second fingerprint 290 may be calculated mathematically from the virtual address 270. Thus, the second fingerprint 290 may be obtained from the hash tier 190 directly based on the virtual 228, without the need for any additional data access.

One should appreciate that the virtual 228 may include other metadata besides that shown, such as a reference count, a compressed size of the pointed-to physical block, and the like. In addition, some embodiments may exclude the checksum 250 and/or the virtual address 270. The virtual 228 as shown is thus intended to be illustrative rather than limiting.

FIG. 2 further shows an example arrangement for supporting deduplication. For instance, a candidate block 212c may be deduplicated by reference to the above-mentioned block 212t, which is designated here as a target block. As shown, logical block 212c has its own path 218 through the mapper 220, but the leaf 226c in the path 218 points to the virtual 228t, the same virtual that was in path 216. Thus, deduplication can be achieved at the leaf level by pointing different blocks to the same virtual 228. For example, storage of the candidate block 212c can be effectuated by reference to the target block 212t, e.g., by establishing a pointer in the leaf 226c so that it points to the virtual 228t.

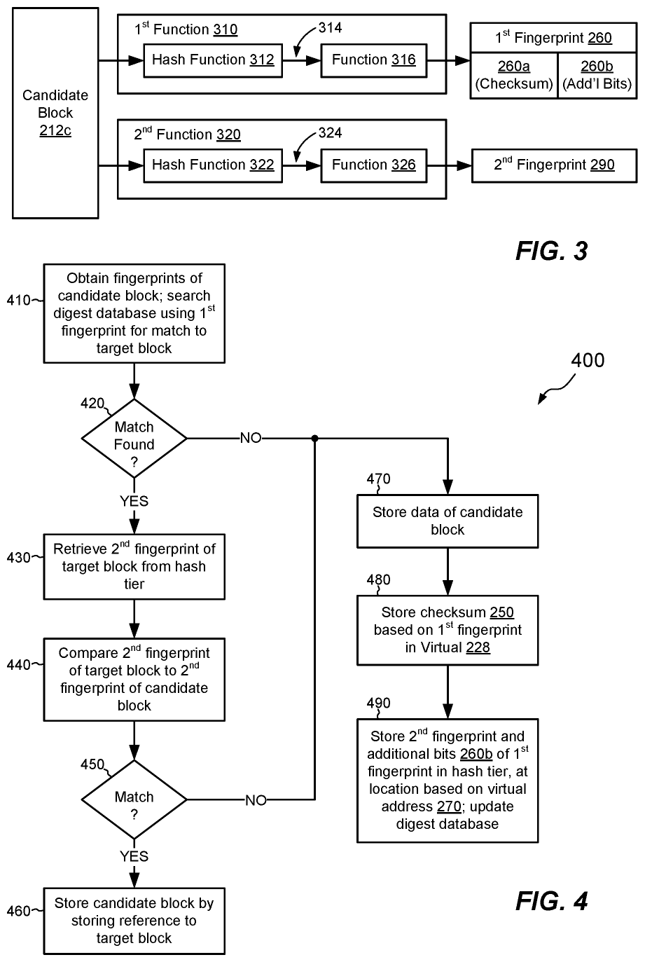

FIG. 3 shows an example arrangement for generating fingerprints 260 and 290 from a candidate block 212c. Here, a first function 310 receives the candidate block 212c as input and generates the first fingerprint 260 as output. The first function may include a hash function 312 and an optional function 316 (which may be omitted in some embodiments). In an example, the hash function 312 is an efficient hash function, which is less burdensome to execute than a fully cryptographic hash function and which produces smaller results. As a non-limiting example, the hash function 312 may be configured to produce 64-bit hash values 314. Such hash values 314 may be used for deduplication, but they are not immune to hash collisions. Optional function 316 modifies the hash values 314, e.g., by truncating such values (e.g., to 56 bits) to support more efficient computations.

As described above, first fingerprints 260 are used to identify potential target blocks during deduplication. For example, the deduplication facility 140 performs hash-based lookups into the digest database 142 using first fingerprints 260.

The first fingerprints 260 may each include two portions 260a and 260b. The first portion 260a may provide a checksum of the candidate block 212c. For example, the checksum may be formed from a defined set of bits of the first fingerprint 260, or from the entire first fingerprint 260. The checksum for a block may be stored as the checksum 250 in the virtual 228 associated with that block (FIG. 2), for example. At any point during system operations, the storage system may perform data validation on the block by executing the first function 310 on the block and by forming a checksum based on the defined set of bits. The storage system 116 may then compare the calculated checksum with the checksum 250 already stored for the same block in the virtual 228. A match indicates valid data; a mismatch indicates corruption.

The second portion 260b of the first fingerprint 260 may include additional bits. These additional bits are simply those bits of the first fingerprint 260 that are not required for the checksum. For example, the checksum may have an optimal size, and anything larger than that size may be excluded from the checksum for best performance. In an example, the additional bits are stored along with corresponding second fingerprints 290 in the hash tier 190.

As further shown in FIG. 3, the candidate block 212c may be processed by a second function 320 for generating the second fingerprint 290 as output. The second function 320 includes a hash function 322, which produces a second hash value 324, and an optional function 326. In an example, the hash function 322 is a strong hash function, stronger than the hash function 312 used to create the first fingerprint 260. Nonlimiting examples of the hash function 322 include the well-known SHA-1 and SHA-2 functions. The hash function 322 may be more burdensome to compute than the hash function 312, but it is computed less often and is not needed for generating a checksum.

In an example, the storage system 116 does not require the full size of the second hash value 324 to guarantee collision-free deduplication. Rather, the needed number of bits of the second hash value 324 is only that number which, when combined with the number of bits in the first fingerprint 260, provides sufficient entropy to guarantee no collisions across the maximum expected number of blocks in the storage system 116. If we assume that this maximum number is 10¹², then the probability of a hash collision statistically approaches zero with a total of 171 bits. If we assume that the size of the first fingerprint 260 is 56 bits, that leaves 115 bits as the optimal size of the second fingerprint 290. Thus, function 326 may truncate the second hash value 324 to 115 bits without risking hash collisions. As indicated above, the second fingerprint 290 may be stored in the hash tier 190, e.g., at a location that can be calculated based on the virtual address 270 (FIG. 2).

In an example, the storage system 116 calculates both the first fingerprint 260 and the second fingerprint 290 upon data ingest, e.g., when first receiving a candidate block for storage. For example, the storage system 116 calculates the first and second fingerprints while performing a memory copy of the candidate block from kernel buffers to cache. In this manner, fingerprints may be calculated when calculations are unlikely to cause substantial additional delays.

FIG. 4 shows an example method 400 of performing deduplication in the environment of FIG. 1. The acts of method 400 are typically performed by the deduplication facility 140 and may be carried out in any suitable order, including performing some acts simultaneously.

At 410, the deduplication facility 140 obtains first and second fingerprints 260 and 290 of a candidate block 212c. The deduplication facility 140 may calculate the fingerprints in the case of local deduplication, or it may receive the fingerprints from a replication source in the case of replication. The deduplication facility 140 searches the digest database 142 using the first fingerprint 260 as a key, i.e., in an attempt to find a target block 212t with a matching first fingerprint.

At 420, if a match to a target block 212t is found, then operation proceeds to 430, whereupon the deduplication facility 140 retrieves a second fingerprint 290 of the matching target block 212t, e.g., from the hash tier 190. For example, the matching entry in the digest database 142 includes a pointer to the virtual 228t of the target block 212t (FIG. 2). The virtual 228 stores or otherwise indicates a virtual address 270, which implies the location of the second fingerprint 290 in the hash tier 190, e.g., based on a predetermined mathematical relationship.

At 440, the deduplication facility 140 compares the second fingerprint 290 (retrieved at 430) of the target block 212t with the second fingerprint 290 of the candidate block 212c.

At 450, if the two second fingerprints match, then the target block 212t is confirmed to be a match to the candidate block 212c and deduplication can proceed.

At 460, the storage system effectuates storage of the candidate block 212c by reference to the target block 212t, e.g., by configuring a pointer in leaf 226c (FIG. 2) to point to the virtual of the target block 212t, i.e., virtual 228t. Effective storage of the candidate block 212c is thus achieved without having to separately store the data of the candidate block 212c. Redundant storage is therefore avoided.

If the attempt at deduplication fails, either at 420 or at 450, then operation proceeds to 470, whereupon the data of the candidate block 212c is stored, e.g., in a newly allocated physical block 232. At 480, the storage system identifies or otherwise determines a checksum of the candidate block 212c from the first fingerprint 260 (as shown in FIG. 3). The storage system also updates a virtual 228 of the candidate block 212c to store the determined checksum as checksum 250. At 490, the storage system stores the second fingerprint 290 of the candidate block 212c in the hash tier 190, e.g., at a location implied by the virtual address 270 of the virtual 228 associated with the candidate block 212c. Any additional bits of the first fingerprint 260 (portion 260b) of the candidate block 212c may be stored at the same location. Also, at or around this time, the deduplication facility 140 may update the digest database 142 to include a new entry for the candidate block 212c. For example, the new entry associates the first fingerprint 260 of the candidate block 212c with a pointer to the virtual 228 of the candidate block 212c.

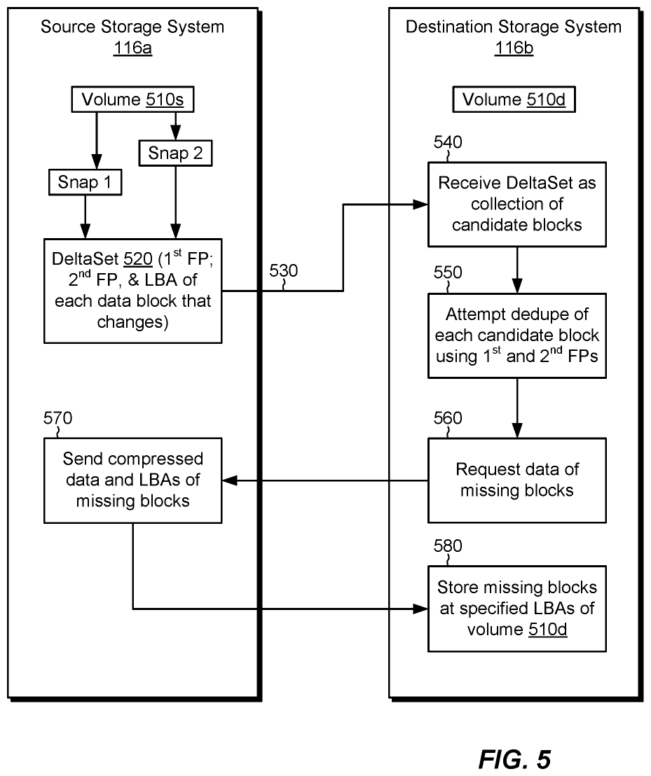

FIG. 5 shows an example arrangement for performing replication facilitated by fingerprints 260 and 290. As shown, a source storage system 116a and a destination storage system 116b are configured to perform replication of a data object 510s (e.g., a volume) on the source 116a by maintaining a replica 510d of that data object at the destination 116b. Replication proceeds based on snapshots (point-in-time versions) of the volume 510s. For example, a first snapshot (Snap 1) of volume 510s is taken at a first point in time and a second snapshot (Snap 2) of the same volume 510s is taken at a second point in time, which is later than the first point in time. As the volume 510s may be a live, production data object, it is expected that Snap 2 differs from Snap 1, with the difference reflecting changes in the volume 510s between the first point in time and the second point in time. To capture this difference, the source 116a generates a deltaset 520, which identifies blocks found in Snap 2 but not in Snap 1. Here, such blocks are identified by listing, for each block, a first fingerprint 260 of the block, a second fingerprint 290 of the block, and an LBA of the block, e.g., a logical address of the block within the volume 510c. The deltaset 520 may list many blocks, but it does not include the data of such blocks.

As shown by arrow 530, the source 116a sends the deltaset to the destination 116b. At 540, the destination 116b receives the deltaset 520 and treats the blocks identified therein as candidate blocks for deduplication.

At 550, the destination 116b attempts to deduplicate the candidate blocks, e.g., in the same manner as shown in FIG. 4, by using the first and second fingerprints provided in the deltaset 520. If a candidate block is successfully deduplicated, storage of the candidate block in the replica 510d may be effectuated by associating the LBA received for that block (as represented in the replica 510d) with a target block identified during deduplication. Thus, the candidate block may be stored without having to transfer the data of the candidate block from source 116a to destination 116b.

Some candidate blocks listed in the deltaset 520 may be missing at the destination 116b. At 560, the destination 116b identifies the missing blocks, i.e., the candidate blocks for which no target blocks are found, and sends a request for the missing blocks to the source 116a.

At 570, the source 116a responds to the request by sending compressed versions of the missing blocks and their associated LBAs to the destination 116b. At 580, the destination 116b receives the missing blocks and stores them at the specified LBAs in the replica 510d.

Replication may proceed over time in this manner, by taking additional snapshots of volume 510s, identifying deltasets 520 between new snapshots and their immediate predecessors, and sending the deltasets 520 to the destination 116b, where the above-described activities are repeated. In this manner, the replica 510d is kept current with the volume 510s over time.

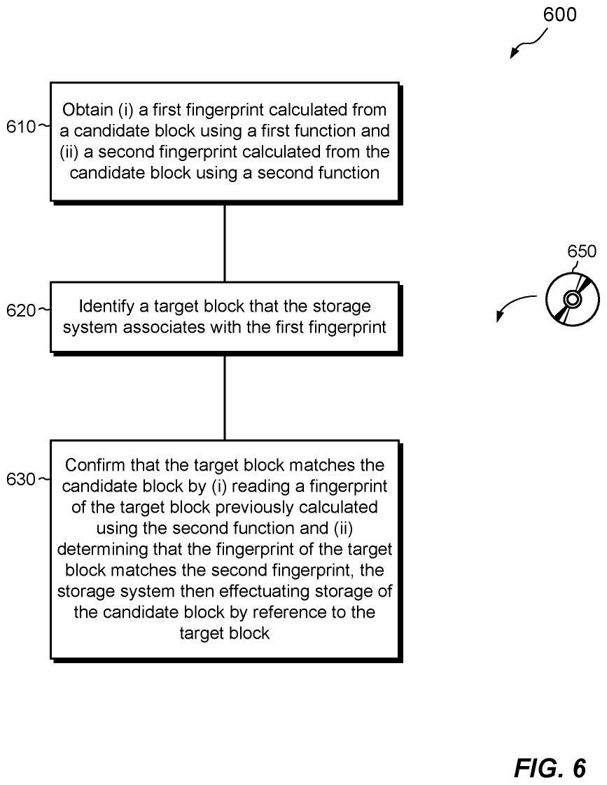

FIG. 6 shows an example method 600 that may be carried out in connection with the environment 100 and provides a review of some of the features described above. The method 600 is typically performed, for example, by the software constructs described in connection with FIG. 1, which reside in the memory 130 of a node 120 and are run by the set of processors 124. The various acts of method 600 may be ordered in any suitable way.

At 610, a storage system 116 obtains both (i) a first fingerprint 260 calculated from a candidate block 212c using a first function 310 and (ii) a second fingerprint 290 calculated from the candidate block 212c using a second function 320. Fingerprints 260 and 290 may be calculated locally, e.g., in the case of local deduplication, or they may be received from another storage system, e.g., in the case of replication.

At 620, the storage system 116 identifies a target block 212t that the storage system associates with the first fingerprint 260. For example, the storage system 116 performs a lookup into the digest database 142 using the first fingerprint 260 as a key. The lookup may yield a match to an entry in the digest database 142 that indicates a target block 212t, e.g., by specifying a pointer to a virtual 228 associated with the target block 212t.

At 630, the storage system 116 confirms that the target block 212t matches the candidate block 212c by (i) reading a fingerprint of the target block 212t previously calculated using the second function 320 and (ii) determining that the fingerprint of the target block 212t matches the second fingerprint 290 of the candidate block 212c. The storage system 116 then effectuates storage of the candidate block 212c by reference to the target block 212t, e.g., by pointing the candidate block 212c to a virtual 228t of the target block 212t.

An improved technique has been described for performing deduplication on a candidate block 212c. The technique calculates a first fingerprint 260 of the candidate block 212c using a first function 310 and a second fingerprint 290 of the candidate block 212c using a second function 320. The technique uses the first fingerprint 260 to identify a target block 212t, which is a potential match to the candidate block 212c in the storage system 116. The technique then attempts to verify the potential match by accessing a fingerprint of the target block 212t, which was previously calculated using the second function 320. The technique compares the fingerprint of the target block 212t to the second fingerprint 290 of the candidate block 212t. A match between the two fingerprints confirms that the data of the candidate block 212c matches the data of the target block 212t. Storage of the candidate block 212c can then be effectuated by reference to the target block.

Having described certain embodiments, numerous alternative embodiments or variations can be made. For example, although embodiments have been described that involve one or more data storage systems, other embodiments may involve computers, including those not normally regarded as data storage systems. Such computers may include servers, such as those used in data centers and enterprises, as well as general purpose computers, personal computers, and numerous devices, such as smart phones, tablet computers, personal data assistants, and the like.

Further, although features have been shown and described with reference to particular embodiments hereof, such features may be included and hereby are included in any of the disclosed embodiments and their variants. Thus, it is understood that features disclosed in connection with any embodiment are included in any other embodiment.

Further still, the improvement or portions thereof may be embodied as a computer program product including one or more non-transient, computer-readable storage media, such as a magnetic disk, magnetic tape, compact disk, DVD, optical disk, flash drive, solid state drive, SD (Secure Digital) chip or device, Application Specific Integrated Circuit (ASIC), Field Programmable Gate Array (FPGA), and/or the like (shown by way of example as medium 650 in FIG. 6). Any number of computer-readable media may be used. The media may be encoded with instructions which, when executed on one or more computers or other processors, perform the process or processes described herein. Such media may be considered articles of manufacture or machines and may be transportable from one machine to another.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Also, a “set of” elements can describe fewer than all elements present. Thus, there may be additional elements of the same kind that are not part of the set. Further, ordinal expressions, such as “first,” “second,” “third,” and so on, may be used as adjectives herein for identification purposes. Unless specifically indicated, these ordinal expressions are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Also, and unless specifically stated to the contrary, “based on” is intended to be nonexclusive. Thus, “based on” should be interpreted as meaning “based at least in part on” unless specifically indicated otherwise. Although certain embodiments are disclosed herein, it is understood that these are provided by way of example only and should not be construed as limiting.

Those skilled in the art will therefore understand that various changes in form and detail may be made to the embodiments disclosed herein without departing from the scope of the following claims.

What is claimed is:

1. A method of performing deduplication in a storage system, comprising:
obtaining (i) a first fingerprint calculated from a candidate block using a first function and (ii) a second fingerprint calculated from the candidate block using a second function;
identifying a target block that the storage system associates with the first fingerprint; and
confirming that the target block matches the candidate block by (i) reading a fingerprint of the target block previously calculated using the second function and (ii) determining that the fingerprint of the target block matches the second fingerprint, the storage system then effectuating storage of the candidate block by reference to the target block.

2. The method of claim 1, wherein at least a portion of the first fingerprint provides a checksum of the candidate block, and wherein the method further comprises validating the candidate block by:
retrieving the checksum of the candidate block from a storage location;
computing a fingerprint of the candidate block using the first function; and
comparing the retrieved checksum with a checksum obtained from the computed fingerprint.

3. The method of claim 1, wherein the first fingerprint has insufficient entropy to unambiguously identify a match between the candidate block and the target block in the storage system.

4. The method of claim 3, further comprising realizing the second function using both (i) a hash function that generates a hash value and (ii) a truncation function that truncates the hash value to a fewer number of bits.

5. The method of claim 3, further comprising providing a persistent storage region that stores second fingerprints of respective data blocks previously stored in the storage system, the second fingerprints calculated using the second function.

6. The method of claim 5, further comprising providing access to the second fingerprints of the respective data blocks at locations in the persistent storage region that are calculated based on addresses associated with the respective data blocks.

7. The method of claim 3, wherein obtaining the first fingerprint and the second fingerprint includes:
the storage system calculating the first fingerprint of the candidate block using the first function; and
the storage system calculating the second fingerprint of the candidate block using the second function.

8. The method of claim 3, further comprising:
calculating a new first fingerprint of a data block using the first function;
calculating a new second fingerprint of the data block using the second function;
storing, in a metadata element provided for the data block, a checksum of the data block, the checksum derived from the new first fingerprint; and
storing the new second fingerprint in a persistent storage region at a location indicated by the metadata element.

8. The method of claim 8, wherein the first new fingerprint includes at least a first portion and a second portion, wherein the checksum is derived from the first portion, and wherein the method further comprises storing the second portion in the persistent storage region at the location indicated by the metadata element.

10. The method of claim 3, wherein the storage system is configured as a destination storage system for replication, and wherein obtaining the first fingerprint of the candidate block and the second fingerprint of the candidate block includes receiving the first fingerprint and the second fingerprint but not the candidate block itself in a transmission from a source storage system that stores the candidate block.

11. The method of claim 10, wherein receiving the first fingerprint of the candidate block includes receiving a checksum of the candidate block from the source storage system, the checksum obtained from a metadata element associated with the candidate block in the source storage system.

12. The method of claim 11, wherein receiving the second fingerprint of the candidate block includes obtaining the second fingerprint from a persistent storage region of the source storage system at a location indicated by the metadata element.

13. A computerized apparatus, comprising control circuitry that includes a set of processors coupled to memory, the control circuitry constructed and arranged to:
obtain (i) a first fingerprint calculated from a candidate block using a first function and (ii) a second fingerprint calculated from the candidate block using a second function;
identify a target block that the computerized apparatus associates with the first fingerprint; and
confirm that the target block matches the candidate block by (i) a read of a fingerprint of the target block previously calculated using the second function and (ii) a determination that the fingerprint of the target block matches the second fingerprint, the computerized apparatus configured then to effectuate storage of the candidate block by reference to the target block.

14. The computerized apparatus of claim 13, wherein the control circuitry constructed and arranged to obtain the first fingerprint and the second fingerprint is further constructed and arranged to:
calculate the first fingerprint from the candidate block using the first function; and
calculate the first fingerprint from the candidate block using the second function.

15. The computerized apparatus of claim 13, wherein the computerized apparatus is configured as a replication destination, and wherein the control circuitry constructed and arranged to obtain the first fingerprint and the second fingerprint is further constructed and arranged to receive the first fingerprint and the second fingerprint from a source storage system.

16. A method of performing deduplication-enabled replication, comprising:
calculating, by a source storage system (i) a first fingerprint of a candidate block using a first function and (ii) a second fingerprint of the candidate block using a second function;
sending, by the source storage system, the first fingerprint and the second fingerprint to a destination storage system;
identifying, by the destination storage system, a target block that the destination storage system associates with the first fingerprint; and
confirming, by the destination storage system, that the target block matches the candidate block by (i) reading a fingerprint of the target block previously calculated using the second function and (ii) determining that the fingerprint of the target block matches the second fingerprint, the destination storage system then effectuating storage of the candidate block by reference to the target block.

17. The method of claim 16, wherein sending the first fingerprint to the destination storage system includes:
reading, by the source storage system, a checksum of the candidate block from a metadata element that the source storage system associates with the candidate block; and
providing the checksum to the destination storage system.

18. The method of claim 17, wherein sending the second fingerprint to the destination storage system includes:
reading, by the source storage system, a data element from a persistent storage region at a location that the source storage system associates with the candidate block; and
providing the data element to the destination storage system.

19. The method of claim 18, wherein the first fingerprint includes a first portion and a second portion, the first portion stored in the checksum and the second portion including additional bits of the first fingerprint not stored in the checksum, and wherein the data element includes both the second fingerprint and the second portion of the first fingerprint.

20. The method of claim 18, wherein sending the first fingerprint and the second fingerprint to the destination storage system is performed as part of an asynchronous replication operation in which the source storage system sends multiple first fingerprints and second fingerprints of respective candidate blocks to the destination storage system.
